(19) United States
(12) Patent Application Publication
(10) Pub. No.: US 2012/0067649 A1
(43) Pub. Date: Mar. 22, 2012

(54) SLIP FREE DRILL PIPE

(75) Inventor: Gerald E. Wlson, Montgomery, TX (US)

(73) Assignee: National Oilwell Varco, L.P., Houston, TX (US)

(21) Appl. No.: 13/320,815

(22) PCT Filed: Apr. 27, 2010
(86) PCT No.: PCT/US2010/032478

§ 371 Date: Nov. 16, 2011

Related U.S. Application Data
(60) Provisional application No. 61/185,090, filed on Jun. 8, 2009.

(51) Int. Cl. E21B 17/00; B23P 11/00

(52) U.S. Cl. 175/320; 29/428

(57) ABSTRACT

A drill pipe includes a pin-type connector part, a box-type pipe connector part, a tube part attached to the pin-type pipe connector part, and an intermediary pipe part disposed between and attached to the box-type pipe connector part and the tube part. The intermediary pipe part has a shoulder for engagement with a handling tool.

### CROSS-REFERENCE TO RELATED APPLICATIONS

This application claims the benefit of U.S. Provisional Application No. 61/185090, filed 8 Jun. 2009, the entire contents of which is hereby incorporated by reference.

### FIELD

The present invention relates to drill pipes and methods of suspending drill pipes, for example, from above a borehole.

### BACKGROUND

Oil and gas producers are having to drill deeper and deeper boreholes into subsurface reservoirs in order to maintain or increase their reserves of oil and gas. Boreholes with depths in a range from 10,000 ft to 15,000 ft were common for many years. Now, boreholes with depths exceeding 30,000 ft are becoming more common. A borehole is drilled using a drill string made up of drill pipes and a bottom hole assembly. A rotary table or power drive, arranged above the borehole, engages the top of the drill string and rotates the drill string to drill the borehole. During the drilling operation, it is necessary from time to time to add drill pipes to or remove drill pipes from the drill string. One reason for adding drill pipes to the drill string is to make the drill string of sufficient length to reach the desired depth of the borehole. One reason for removing drill pipes from the drill string is to retrieve the drill string from the borehole so that changes can be made to the bottom hole assembly appended to the bottom of the drill string. Drill pipes are typically added to or removed from the drill string in the form of stands, where each stand is made up of multiple connected drill pipes.

While a stand or pipe is being added to or removed from the drill string, the drill string has to be suspended in the borehole from a position above the borehole. Typically, a suspension mechanism arranged in the rotary table is used to suspend the drill string. FIG. 1 shows an example of such a suspension mechanism from U.S. Pat. No. 5,853,199 (issued to Gerald E. Wilson). In FIG. 1, a drill pipe 32 is supported by a slip assembly 34, which may be hand-operated or power-operated. The drill pipe 32 represents any pipe on a drill string that may need to be gripped during a drilling operation. Slip assembly 34 includes slip segments 34a, 34b, and 34c (slip segment 34c is behind the drill pipe 32), which are steel wedges that are hinged together to form a near circle around the drill pipe 32. The inner surfaces of the slip segments 34a, 34b, and 34c are outfitted with replaceable slip inserts 50. The inserts 50 are hardened steel teeth that embed slightly into the surface of the pipe 32 in order to grip the pipe 32. The outer surfaces of the slip segments 34a, 34b, and 34c are tapered. Bushings 40, 42, arranged in an opening 38 of a rotary table 36, combine to provide downwardly tapered, converging surfaces 44 that engage the outer tapered surfaces 46 of the segments 34a, 34b, and 34c. While the drill pipe 32 is supported by the slip assembly 34, pipes (not shown) can be unscrewed from the top of drill pipe 32 or pipes (not shown) can be screwed onto the top of drill pipe 32.

The driller places the slip assembly 34 around the pipe 32 so that the box joint 48 of the pipe 32 is above the slip segments 34a, 34b, and 34c. After the slip assembly 34 is placed around the pipe 32, the slip assembly 34 is pulled down. This downward force pulls the slip segments 34a, 34b, and 34c down, providing a compressive force on the surface of the pipe 32 that effectively locks the slip assembly 34 to the pipe 32. The teeth on the slip inserts 50 engage the pipe 32. To support the pipe 32, the teeth on the slip inserts 50 will have to cut notches on the wall of the pipe 32. Also, the area of the pipe 32 gripped by the slip assembly 34 is subjected to compressive hoop stress. This compressive hoop stress will increase as the weight appended to the bottom of the pipe 32 increases. The weight appended to the bottom of the pipe 32 comes from the drill stem (not shown) extending from the drill pipe 32 into the borehole. The weight of the drill stem increases as the borehole is drilled to greater depths and additional pipes are required to reach the desired depth of the borehole. The notches formed on a slip-supported pipe, such as pipe 32, will accumulate over time and will eventually require that the pipe be downgraded because of reduced wall thickness or retired because of cracks in the slip area. Notches can also result in premature failure of the pipe. Slip crushing of the drill pipe, due to biaxial loading on the pipe with the slips, is also a concern when landing long and heavy casing strings in a wellhead, on the ocean floor in deep water, with a drill pipe landing string.

### SUMMARY

In a first aspect of the present invention, a drill pipe comprises a pin-type pipe connector part, a box-type pipe connector part, a tube part attached to the pin-type pipe connector part, and an intermediary pipe part disposed between and attached to the box-type pipe connector part and the tube part. The intermediary pipe part has a shoulder for engagement with a handling tool.

In a second aspect of the present invention, a method of making a drill pipe comprises (a) attaching a pin-type connector part to a tube part, (b) attaching an intermediary pipe part to the tube part, the intermediary pipe part having a shoulder for engagement with a handling tool, and (c) attaching a box-type connector part to the intermediary pipe part.

In a third aspect of the present invention, a method of making a drill pipe comprises (a) integrally forming an intermediary pipe part with a box-type pipe connector, the intermediary pipe part having a shoulder for engagement with a handling tool, (b) attaching a tube part to the intermediary pipe part, and (c) attaching a pin-type pipe connector to the tube part.

Other aspects of the present invention will be apparent from the following description and the appended claims.

### BRIEF DESCRIPTION OF DRAWINGS

The following is a description of the figures in the accompanying drawings. The figures are not necessarily to scale, and certain features and certain views of the figures may be shown exaggerated in scale or in schematic in the interest of clarity and conciseness.

FIG. 1 shows a drill pipe supported in a rotary table with slips.

FIG. 2 is a cross-section of a drill pipe with an intermediary pipe part for handling of the drill pipe.

FIG. 3 is a cross-section of a drill pipe with an intermediary pipe part for handling of the drill pipe integrally formed with a box-type pipe connector.

FIG. 4 is a cross-section of a drill pipe supported by a handling tool.

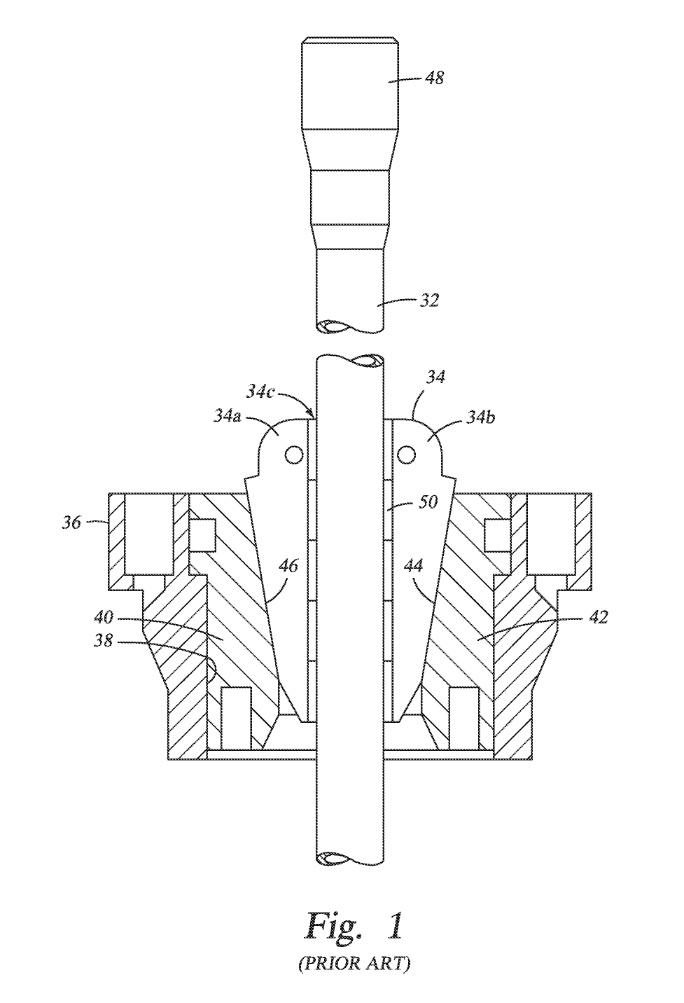

### DETAILED DESCRIPTION

In the following detailed description, numerous specific details may be set forth in order to provide a thorough understanding of embodiments of the invention. However, it will be clear to one skilled in the art when embodiments of the invention may be practiced without some or all of these specific details. In other instances, well-known features or processes may not be described in detail so as not to unnecessarily obscure the invention. In addition, like or identical reference numerals may be used to identify common or similar elements.

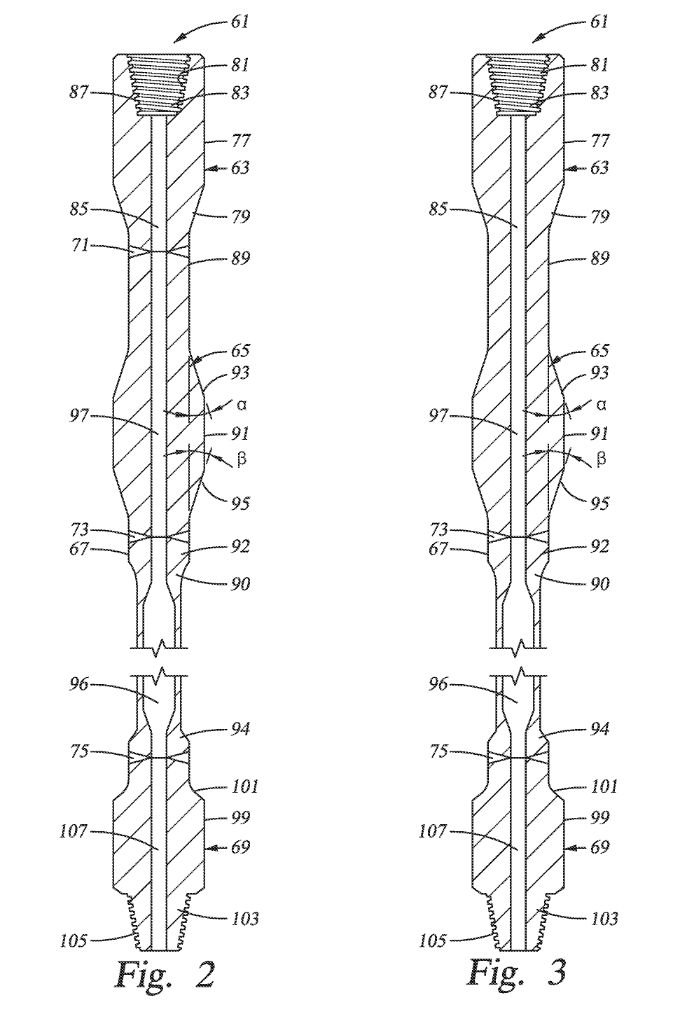

FIG. 2 shows a drill pipe 61 according to an embodiment of the invention. The drill pipe 61 may serve as a drill pipe or other type of oilfield or industrial pipe. The drill pipe 61 includes a box-type pipe connector part 63, an intermediary pipe part 65, a tube part 67, and a pin-type pipe connector part 69. The box-type pipe connector part 63 is attached to the intermediary pipe part 65, which is attached to the tube part 67, which is attached to the pin-type pipe connector part 69.

The box-type pipe connector part 63, intermediary pipe part 65, tube part 67, and pin-type pipe connector part 69 may be made of a metal or alloy, e.g., steel, or a non-metallic material, e.g., a composite material. The choice of material used in the parts will depend on the intended use of the drill pipe and industry specifications.

The joints 71, 73, 75 between the parts of the drill pipe 61 are fixed, secure joints. Where the parts of the drill pipe 61 are made of a metal or alloy, the fixed, secure joints may be provided by welding. One or more of the joints 71, 73, 75 may be eliminated by integrally forming the parts. For example, FIG. 3 shows the drill pipe 61 with the box-type pipe connector part 63 integrally formed with the intermediary pipe part 65, i.e., without a joint between the box-type pipe connector part 63 and the intermediary pipe part 65.

The box-type pipe connector 63 has a bore with threads (i.e., box), and the pin-type pipe connector 69 has a pin with threads. When a first and a second drill pipe are being connected, the pin of a pin-type pipe connector at the end of the first drill pipe will be stabbed and screwed into the box of a box-type pipe connector at the end of the second drill pipe. This process can be repeated until a string of drill pipes having the desired length is achieved.

The intermediary pipe part 65 provides a thick-walled area between the box-type pipe connector part 63 and the tube part 67 where the drill pipe 61 can be engaged without the use of slips and slip inserts.

An embodiment of the box-type pipe connector part 63 includes a tube 77 with a shoulder 79. Shoulder 79 can be engaged by a handling tool, e.g., in order to support the drill pipe 61. The box-type pipe connector part 63 has an internal bore 81. The thickness of the wall of the box-type pipe connector part 63 is non-uniform along the length of the box-type pipe connector part 63. The inner diameter of the box-type pipe connector part 63 (or the diameter of the bore 81) is non-uniform along the length of the box-type pipe connector part 63. The bore 81 has a tapered bore section 83 and a straight bore section 85. The surface defining the tapered bore section 83 includes threads 87 for threaded engagement with a pin-type pipe connector of another drill pipe, which may or may not be structurally similar to the drill pipe 61.

An embodiment of the intermediary pipe part 65 has a pipe 89 and a raised section 91 formed on the pipe 89. Shoulder 95 is formed at an end of the raised section 91. Shoulder 95 may be tapered (with the angle β ranging from greater than 0° to 90°) or square (with the angle β equal to 90°). Examples of shoulder angles, which are not to be considered as limiting, are 18°, 35°, 45°, and 90°. As will be explained below, shoulder 95 and raised section 91 provide a thick-walled area where a handling tool can engage and support the drill pipe 61. The junction 93 between the pipe 89 and raised section 91 may be tapered (with the angle α ranging from greater than 0° to 90°) or square (with the angle α equal to 90°.

The intermediary pipe part 65 has an internal bore 97, which is aligned with the internal bore 81 of the box-type pipe connector part 63. The inner diameter of the pipe 89 is shown as being essentially uniform along the length of the pipe 89. In alternate embodiments, the inner diameter of the pipe 89 may be non-uniform along the length of the pipe 89. The thickness of the wall of the pipe 89 changes along the length of the pipe 89 and is maximum at the raised section 91. The outer diameter of the raised section 91 of the intermediary pipe part 65 can be the same or smaller than the outer diameter of the tube 77 of the box-type pipe connector part. The pipe 89 of the intermediary pipe part 65 is attached, e.g., by welding or other attaching means, to the tapered end 79 of the box-type pipe connector part 63, as shown in FIG. 2, or integrally formed with the tapered end 79 of the box-type pipe connector part 63, as shown in FIG. 3.

An embodiment of the tube part 67 has a tube 90 with upset ends 92, 94. The tube part 67 is the longest and main part of the drill pipe 61, typically several feet long. Except for the upset ends 92, 94, the thickness of the wall of the tube part 67 is essentially uniform and is smaller than the thickness of the wall of the intermediary pipe part 65 at the raised section 91. The tube part 67 has an internal bore 96, which is aligned with the internal bore 97 of the intermediary pipe part 65. The upset end 94 of the tube part 67 is joined, e.g., by welding or other attaching means, to the adjacent end of the intermediary pipe part 65 so that the shoulder 95 is between the raised section 91 and the tube part 67.

An embodiment of the pin-type pipe connector part 69 includes a pipe 99 with an upset end 101 and a tapered or pin end 103. Threads 105 are formed on the outer surface of the tapered end 103 for threaded engagement with the internal threaded bore of a box-type pipe connector part on another pipe, which may or may not be structurally similar to the drill pipe 61. The thickness of the wall of the pin-type pipe connector part 69, or the outer diameter of the pin-type pipe connector part 69, is non-uniform along the length of the pin-type pipe connector part 69. The pin-type pipe connector part 69 has an internal bore 107, which is aligned with the internal bore 96 of the tube part 67. The inner diameter of the pin-type pipe connector part 69 (or the diameter of the bore 107) is shown as being uniform along the length of the pin-type pipe connector part 69. In alternate embodiments, the inner diameter of the pin-type pipe connector part 69 may be non-uniform. The upset end 101 of the pin-type pipe connector part 69 is joined, e.g., by welding or other attaching means, to the upset end 94 of the tube part 67.

The intermediary pipe part 65 is configured to be engaged by a handling tool, e.g., for the purpose of suspending the drill pipe 61 in a vertical position from above a borehole. The handling tool can engage the intermediary pipe part 65 at the shoulder 95 at the lower end of the raised section 91. The handling tool can be any apparatus capable of supporting a pipe or pipe string by engaging a shoulder formed at an end of a raised section on a pipe. Examples of handling tools include, but are not limited to, collar, ring, harness, yoke, and elevator. The intermediary pipe part 65 eliminates the need to engage the drill pipe 61 with slips that can cut notches on the pipe, induce compressive hoop stress in the wall of the pipe, and crush the pipe.

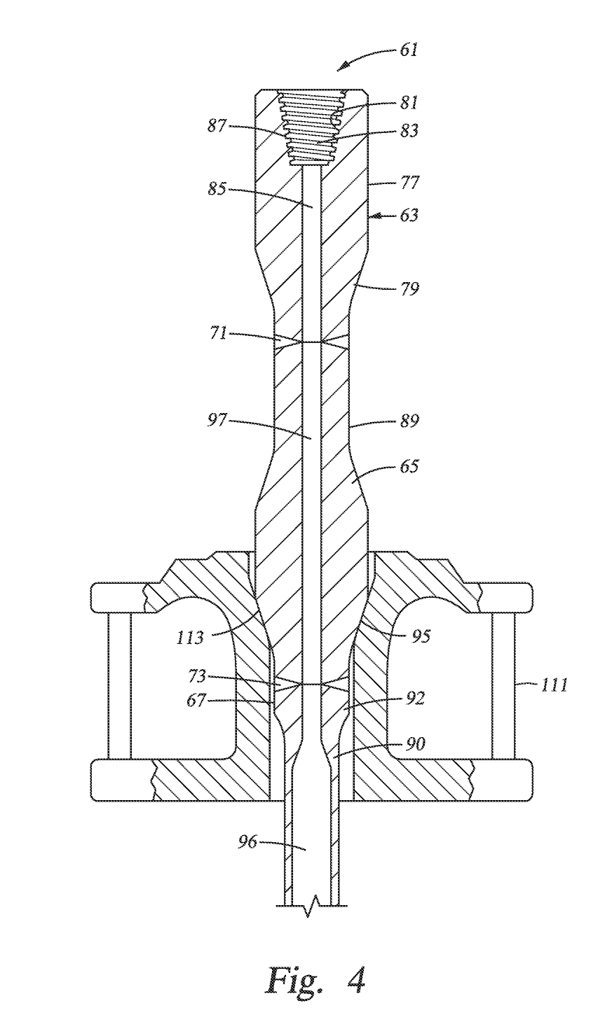

FIG. 4 shows the drill pipe 61 supported by a handling tool 111. The handling tool 111 has a shoulder 113 that forms a seat for one of the shoulders at the raised section 91 of the intermediary pipe part 65. The shoulder 95 of the intermediary pipe part 65 sits on the shoulder 113 of the handling tool 111. The angle of the shoulder 113 is complementary to the angle of the shoulder 95 so that the shoulder 113 can mate with the shoulder 95 and thereby allow the handling tool 111 to support the drill pipe 61. The handling tool 111 can be suitably supported to suspend the drill pipe in a vertical position. The handling tool 111 may be, for example, a side door elevator such as described in U.S. Pat. No. 7,303,021 (issued to Schats et al.).

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A drill pipe, comprising:
a pin-type pipe connector part;
a box-type pipe connector part;
a tube part attached to the pin-type pipe connector part; and
an intermediary pipe part disposed between and attached to the box-type pipe connector part and the tube part, the intermediary pipe part having a shoulder for engagement with a handling tool.

2. The drill pipe of claim 1, wherein the shoulder is proximate to an end of the tube part.

3. The drill pipe of claim 1, wherein the intermediary pipe part has a raised section and the shoulder is formed at an end of the raised section.

4. The drill pipe of claim 3, wherein an outer diameter of the raised section is greater than an outer diameter of the tube part.

5. The drill pipe of claim 4, wherein a thickness of a wall of the intermediary pipe part at the raised section is greater than a thickness of a wall of the tube part.

6. The drill pipe of claim 1, wherein the intermediary pipe part is integrally formed with the box-type pipe connector part.

7. The drill pipe of claim 1, wherein an angle between the shoulder and a longitudinal axis of the drill pipe ranges from greater than 0° to 90°.

8. The drill pipe of claim 1, wherein the box-type pipe connector part has a shoulder for engagement with a handling tool.

9. A method of making a drill pipe, comprising:
(a) attaching a pin-type pipe connector part to a tube part;
(b) attaching an intermediary pipe part to the tube part, the intermediary pipe part having a shoulder for engagement with a handling tool; and
(c) attaching a box-type pipe connector part to the intermediary pipe part.

10. The method of claim 9, wherein in (b), the intermediary pipe part has a raised section and the intermediary pipe part is attached to the tube part such that the shoulder is located between the raised section and the tube part.

11. The method of claim 9, wherein in (c), the box-type connector part attached to the intermediary pipe part has a shoulder for engagement with a handling tool.

12. A method of making a drill pipe, comprising:
(a) integrally forming an intermediary pipe part with a box-type pipe connector part, the intermediary pipe part having a shoulder for engagement with a handling tool;
(b) attaching a tube part to the intermediary pipe part; and
(c) attaching a pin-type pipe connector part to the tube part.

13. The method of claim 12, wherein in (b), the intermediary pipe part has a raised section and the intermediary pipe part is attached to the tube part such that the shoulder is located between the raised section and the tube part.
